(19) United States
(12) Patent Application Publication
(10) Pub. No.: US 2016/0227705 A1
(43) Pub. Date: Aug. 11, 2016

(54) STRING TRIMMER HEAD

(71) Applicant: Techtronic Industries Co. Ltd., Tsuen Wan (HK)

(72) Inventors: Eric Nolin, Anderson, SC (US); Benjamin H. Cogan, Prosperity, SC (US); Robert L. Morrison, Shreveport, LA (US); Steve Coghill, Easley, SC (US)

(21) Appl. No.: 14/619,411

(22) Filed: Feb. 11, 2015

(51) Int. Cl. A01D 34/416

(52) U.S. Cl. CPC A01D 34/4166

(57) ABSTRACT

A trimmer head and a method for assembling a trimmer head. The trimmer head may generally include a housing rotatable about an axis; a receptacle in the housing to receive a portion of a trimmer line; and a locking member movable in a radial direction relative to the housing between a first position, in which the locking member engages the trimmer line to axially retain the trimmer line relative to the housing, and a second position, in which the trimmer line is movable relative to the receptacle.

### FIELD

The present invention relates to trimmers and, more particularly, to trimmer heads for string trimmers.

### SUMMARY

Generally, trimmers are used to cut grass and weeds, and are often used to edge around trees, near fences and walls, and along landscape borders. Conventional string trimmers include an elongated shaft with a rotating element or gear head near the end of the elongated shaft, and a spool or string head is attached to the gear head. Typically, the string head includes a monofilament line (i.e., trimmer line) that is rotated by the gear head for cutting and trimming along landscaped areas, fences, and walls.

In one independent aspect, a trimmer head may generally include a housing rotatable about an axis; a receptacle in the housing to receive a portion of a trimmer line; and a locking member movable in a radial direction relative to the housing between a first position, in which the locking member engages the trimmer line to axially retain the trimmer line relative to the housing, and a second position, in which the trimmer line is movable relative to the receptacle.

In another independent aspect, a trimmer head may generally include a housing rotatable about an axis; a receptacle in the housing to receive a portion of the trimmer line; and a flexible locking member bendable in a radial direction relative to the housing between a first position, in which the locking member engages the trimmer line to axially retain the trimmer line relative to the housing, and a second position, in which the trimmer line is movable relative to the receptacle.

In yet another independent aspect, a method of assembling a trimmer head is provided. The method may generally include bending a locking member in a radial direction relative to a housing from a first position, in which the locking member at least partially blocks a receptacle, toward a second position, in which a portion of a trimmer line is insertable into the receptacle; inserting the portion of the trimmer line into the receptacle; and moving, with an intrinsic biasing force, the locking member toward the first position to axially retain the trimmer line relative to the housing.

Other independent aspects of the invention will become apparent by consideration of the detailed description, claims and accompanying drawings.

### BRIEF DESCRIPTION OF THE DRAWINGS

FIG. 1 is a perspective view of a trimmer, such as a string trimmer, for use with a trimmer head.

FIG. 2 is a top perspective view of a trimmer head for use with the trimmer shown in FIG. 1.

FIG. 3 is a bottom perspective view of the trimmer head shown in FIG. 2.

FIG. 4 is an exploded view of the trimmer head shown in FIG. 2.

FIG. 4A is a top view of a trimmer line with two strings.

FIG. 5 is a perspective view of trimmer lines used with the trimmer head shown in FIG. 2.

FIG. 6 is a cross-sectional view of the trimmer head shown in FIG. 2.

FIG. 7 is an exploded view of an alternative construction of a trimmer head for use with the trimmer shown in FIG. 1.

FIG. 8 is a cross-sectional view of the trimmer head shown in FIG. 6.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

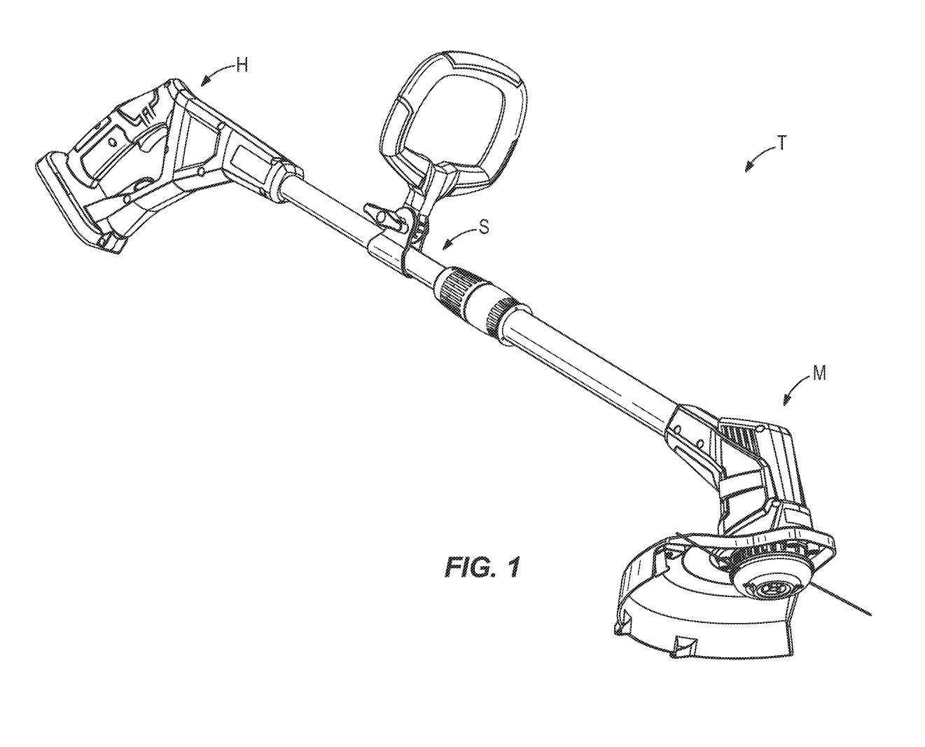

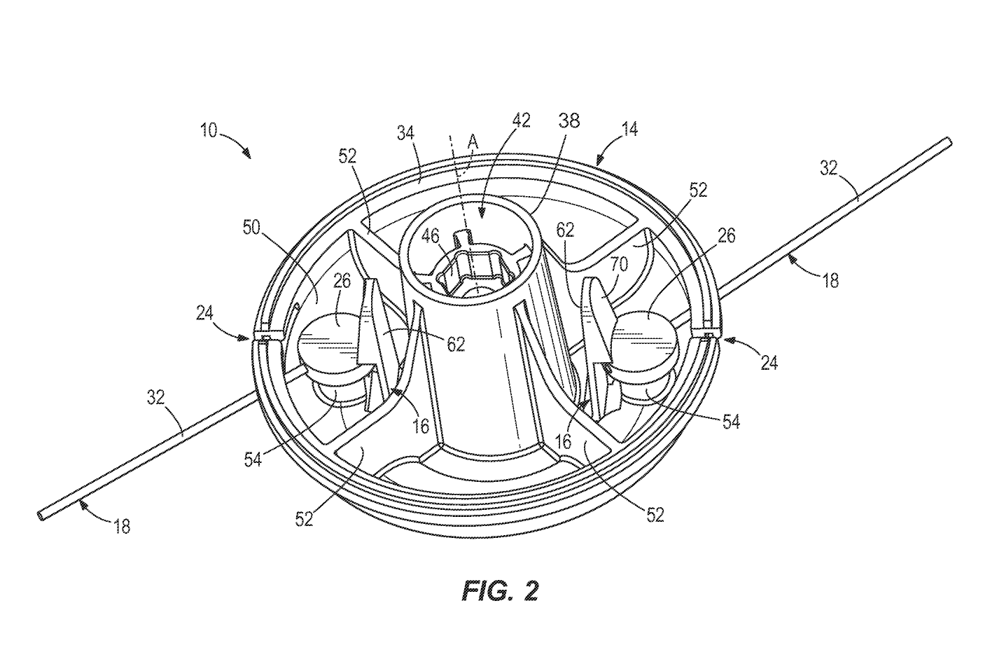

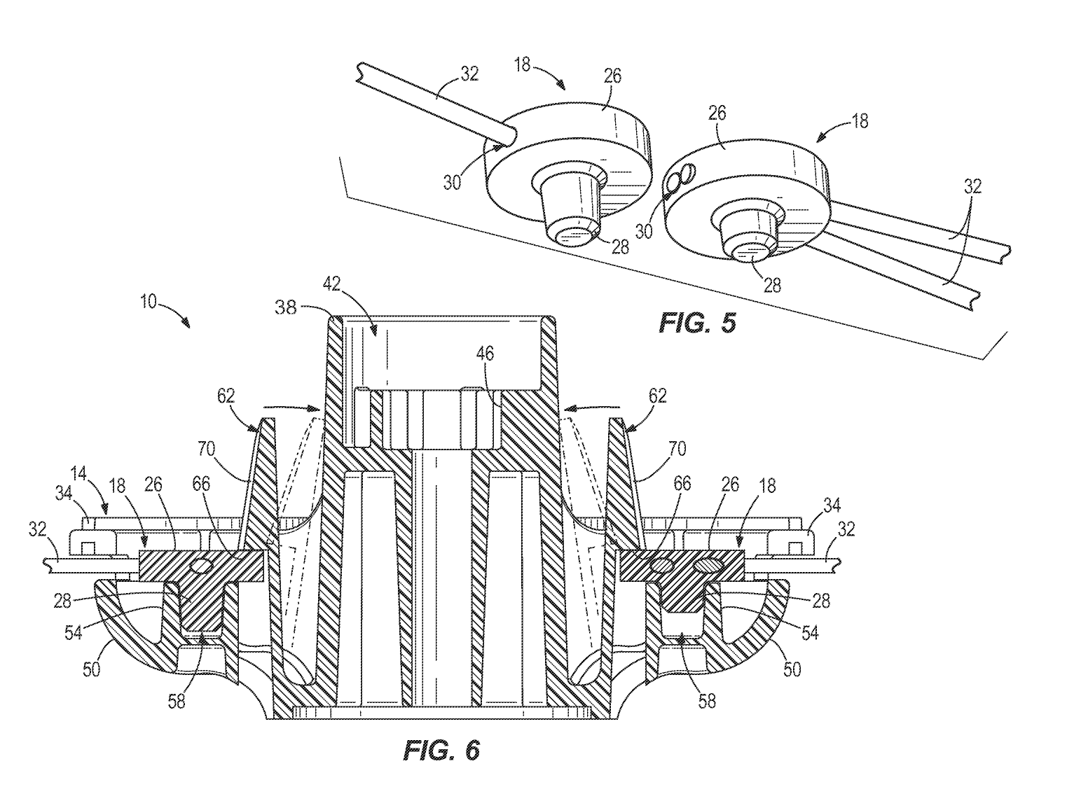

FIGS. 2-6 illustrate a trimmer head 10 for use on an exemplary string trimmer T shown in FIG. 1. The trimmer T generally includes a shaft S with a handle H toward one end and a motor housing M enclosing an electric motor (not shown) with a motor-driven output or drive shaft (not shown) for connection to a trimmer head on the other end. Various powered trimmers (e.g., battery-powered, gas-powered, etc.) may be used with the trimmer head 10.

As illustrated in FIG. 1, the trimmer head 10 includes a housing 14 to at least partially enclose and locking member(s) 16 to selectively retain one or more replaceable trimmer lines 18 for cutting vegetation during operation of the trimmer T. The housing 14 defines at least one opening or slot 22 through which the trimmer line(s) 18 may pass. In the illustrated construction, an entrance passage 24 communicates into each slot 22.

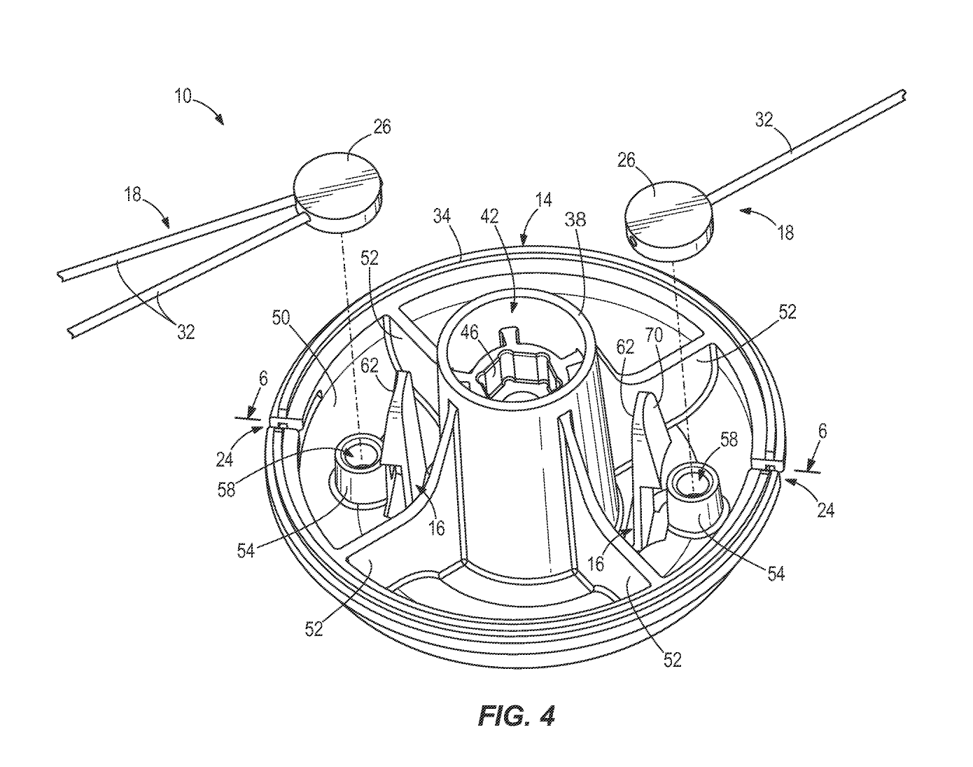

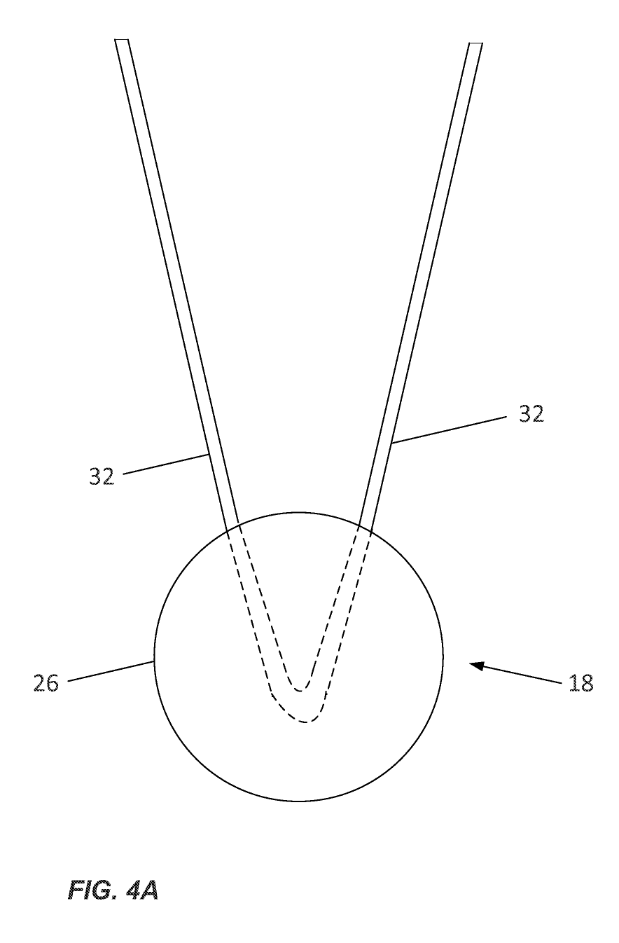

The illustrated trimmer lines 18 include a hub 26 having a protrusion 28 (see FIG. 5) and defining one or more holes 30 to hold cutting string(s) 32. As shown in FIGS. 4-5, the trimmer line(s) 18 used with the trimmer head 10 may include a single cutting string 32, multiple (e.g., two) cutting strings 32, a single folded string with opposite ends providing two cutting strings 32, etc.

In other constructions, the cutting string(s) 32 may be molded into the hub 26. For example (see FIG. 4A), for a “two string” trimmer line 18, a single string may be folded in half, and the hub 26 would be molded around the base of the folded string, with the leg of each half projecting from the hub 26 and providing a string 32.

The cutting string(s) 32 are illustrated with a round cross-section. It should be understood that, in other constructions (not shown), the cutting string(s) 32 may have a different cross-sectional shape (e.g., square, flat, star, etc.). In addition, the outer surface of the cutting string(s) 32 is illustrated as smooth. In other constructions (not shown), the outer surface may be non-smooth (e.g., have teeth, serrations, etc.).

The cutting string(s) 32 may be positioned in the slot 22 through the entrance passage 24. The entrance passage 24 is positioned to be offset from and not aligned with the cutting string(s) 32 during operation to inhibit the string(s) 32 from accidentally exiting the slot 22. If the cutting string(s) 32 contact an obstruction while cutting, the trimmer lines 18 can rotate to, for example, prevent damage to the trimmer head 10, the trimmer lines 18, etc. Each slot 22 allows the cutting string(s) 32 to freely move as the hub 26 pivots relative to the trimmer head 10.

It should be understood that, in some constructions (not shown), an entrance passage 24 may not be provided. In such constructions, each cutting string 32 is inserted through the associated slot 22.

The trimmer head 10 may also include a cap member (not shown) to, for example, limit entry of debris into the trimmer head 10, avoid an undesirable build-up of vegetative debris within the trimmer head 10, etc. Mating features (not shown) may be provided for removably coupling the cap member to the housing 14. For example, a housing mating feature may be associated with a circumferential rim 34 of the housing 14, and a cover mating feature may be on a complementary portion of the cap member.

A cylindrical projection 38 is located at the center of the trimmer head 10 for connection with the drive shaft of the trimmer T. The projection 38 defines an aperture 42 with an attachment feature 46 corresponding to the size and shape of the drive shaft. The drive shaft is connected to the trimmer head 10 via the attachment feature 46 to cause rotation of the trimmer head 10 about an axis A during operation.

The housing 14 includes a curved outer wall 50 (FIG. 2) ending at the circumferential rim 34. The outer wall 50 at least partially defines an inner volume within which the internal end portion of the trimmer line(s) 18 is held. A plurality of support ribs 52 extend from the outer wall 50 to the projection 38 to, for example, provide extra structural support.

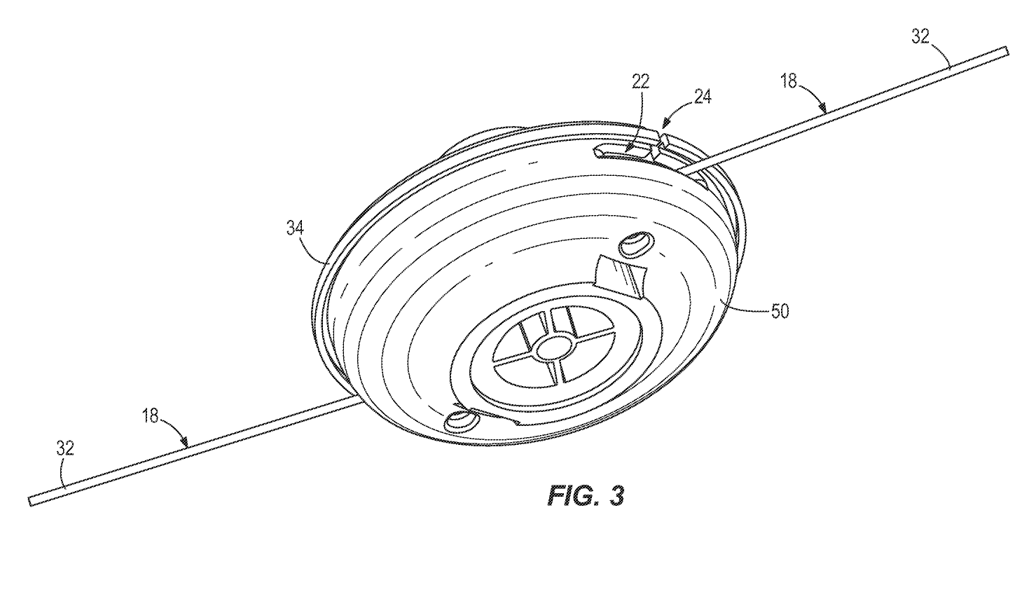

With reference to FIG. 3-5, one or more receptacles 54 are provided in the housing 14, each defining an aperture 58 to hold the associated trimmer line 18. In the illustrated construction, each receptacle 54 receives a protrusion 28 of the associated trimmer line 18 and allows pivotal movement of the trimmer lines 18 with respect to the trimmer head 10. The protrusion 28 may have a different length depending on the desired engagement with the receptacle 54. The receptacle 54 is sized appropriately to receive the protrusion 28.

Each locking member 16 is selectively engageable with an associated trimmer line 18 to prevent or limit movement of the trimmer line 18 relative to the housing 14. The illustrated locking members 16 are movable relative to the housing 14 at least partially in a radial direction, toward and/or away from the axis A. In the illustrated constructions, each locking member 16 includes a flexible “finger” 62 bendable toward and/or away from the axis A. In other constructions (not shown), the locking member 16 may include another structure that is movable at least partially in a radial direction (e.g., an at least partially radially-slidable locking member).

Each finger 62 is movable between an engaged position (shown in solid lines in FIG. 5), in which the finger 62 engages the trimmer line 18 to inhibit removal of the trimmer line 18 from the trimmer head 10, and a disengaged position (shown in phantom lines in FIG. 5), in which the finger 62 is disengaged from and allows removal of the trimmer line 18 from the trimmer head 10. In the illustrated construction, each finger 62 is movable radially outwardly toward the engaged position to prevent axial movement of the trimmer lines 18 and radially inwardly toward the disengaged position to allow axial movement (i.e., entry or removal) of the trimmer lines 18. In the illustrated construction, rotation of the trimmer head 10 and centrifugal force caused by such rotation thus cooperates to maintain the locking member(s) 16 in the engaged position.

As illustrated, each locking member 16 is biased toward the engaged position. In the illustrated construction, the biasing force results from the intrinsic force of the flexible finger(s) 62 tending to move the finger 62 radially outwardly and toward the engaged position. Alternatively or additionally, other forces (e.g., gravity) may bias/contribute to biasing the finger(s) 62. In such constructions, each locking member 16 is moved radially inwardly (in the direction of the arrow in FIG. 5) toward the disengaged position. In this construction, each locking member 16 is “closed” when the trimmer T is in use or not in use and is “opened” by the user.

In the construction shown in FIGS. 2-6, each finger 62 prevents or limits axial movement of the trimmer line 18 relative to the housing 14 (e.g., the protrusions 28 from dislodging from the receptacles 54 in an axial direction) while allowing some pivoting movement of the trimmer line 18 relative to the housing 14. As illustrated, each finger 62 has an engagement surface 66 that, in the engaged position, contacts a surface (e.g., a top surface) of the associated hub 26 to limit axial movement of the hub 26 and, thereby, of the trimmer line 18. Each finger 62 bends radially inwardly toward the disengaged position so that the protrusion 28 of the trimmer line 18 may be inserted into or removed from the receptacle 54 (FIG. 5).

Each finger 62 also includes an actuation surface engageable to move the finger 62 toward the disengaged position. In the illustrated construction, the actuation surface includes a sloped surface 70 engageable by the hub 26 of the trimmer line 18 during insertion to “automatically” cause the finger 62 to bend toward the disengaged position to uncover and allow insertion of the trimmer lines 18 into the receptacles 54. The illustrated surface 70 is curved to better conform to the illustrated cylindrical hub 26 and/or to be more comfortable for engagement by a user's finger.

In an alternative construction, each locking member 16 may be biased (e.g., by an intrinsic force, gravity, etc.) toward the disengaged position (in the direction of the arrow in FIG. 5) so that the associated receptacle 54 is uncovered when the trimmer T is not in use (e.g., when the trimmer head 10 is not being rotated). In such a construction, the user can simply insert the hub 26 of the trimmer line 18 without manipulating the locking member 16. Rotation of the trimmer head 10 and centrifugal force caused by such rotation moves the locking member(s) 16 toward and maintains the locking member(s) 16 in the engaged position during use of the trimmer T. In this construction, each locking member 16 is “open” when the trimmer T is not in use and “closed” only when the trimmer T is in use.

In other constructions (not shown), a separate biasing member (e.g., a spring) may be used, alternatively or additionally, to apply a biasing force. For example, such a biasing member may be used with a locking member which does not have an intrinsic biasing force (e.g., a sliding locking member).

The components of the trimmer head 10 (i.e., the outer wall 50, the projection 38, the ribs 52, the finger(s) 62, etc.) may be formed as a single unit using, for example, an injection molding process. Alternatively, components of the trimmer head 10 may be separate pieces that are coupled (e.g., screwed, adhered, welded, etc.) together to form the trimmer head 10.

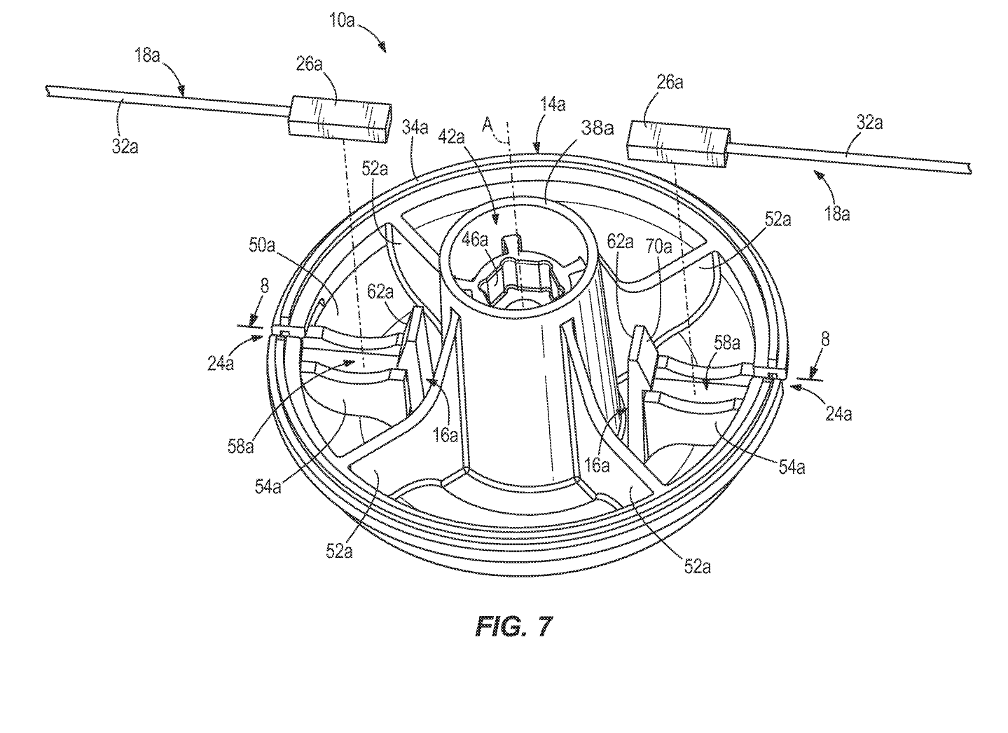

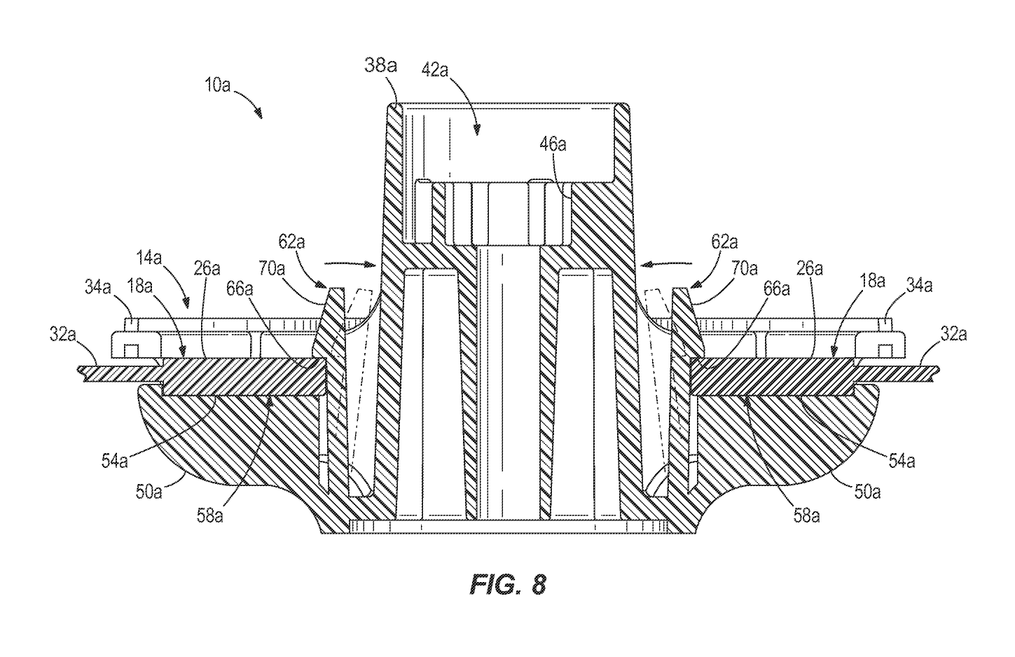

FIGS. 7-8 illustrate an alternative construction of a trimmer head 10a for use with a powered trimmer, such as the trimmer T. Common elements have the same reference character with the letter “a”. The description of the common elements, components and features is similar to the corresponding above description, except as contradicted below.

In the illustrated construction, the trimmer lines 18a are not pivotable relative to the housing 18a. The hubs 26a of the trimmer lines 18a and/or the receptacles 54a are constructed to limit such pivoting movement. In the illustrated construction, each hub 26a is non-cylindrical, and the receptacle 54a has a complementary non-cylindrical shape. In other constructions (not shown), the hub 26a may be provided with a protrusion that is non-cylindrical so that the hub 26a remains non-pivotally coupled to the trimmer head 10a.

In this alternative construction, the trimmer lines 18a will not pivot with respect to the trimmer head 10a upon impact with an obstruction while cutting vegetation. The illustrated “fixed” connection shown in FIGS. 7-8 may be more secure than the pivoting connection shown in FIGS. 2-5. However, the trimmer lines 18a may be subject to greater force during cutting and/or when impacting obstacles and, as a result, may break more easily.

In operation of the trimmer heads 10, 10a, a user may insert the trimmer line 18, 18a into the corresponding receptacle 54, 54a by pressing inwardly on the finger 62, 62a (either with the hub 26, 26a or with a finger). The user may then operate the trimmer T using the cutting string(s) 32, 32a of the trimmer line 18, 18a to cut vegetation. The user may then remove the trimmer line 18, 18a by again pressing inwardly on the finger 62, 62a and pulling the hub 26, 26a out of the receptacle 54, 54a in the axial direction.

For non-round cutting strings 32 (e.g., square, flat, star-shaped, toothed, serrated, etc.), proper orientation of the cutting string 32 relative to the trimmer head 10 and the direction of cutting may be important (e.g., cutting teeth on leading edge rather than on trailing edge, etc.). To ensure proper orientation, the trimmer line 18 and/or the housing 14 may be constructed so that the trimmer line 18 is received by the housing 14 in only the proper orientation(s). For example, in the construction of FIGS. 1-6, orienting structure is provided by the protrusion 28 on the hub 26 and the cooperating aperture 58 in the associated receptacle 54.

In the construction of FIG. 7-8, the hub 26a and/or the receptacle 54a are shaped (e.g., tapered) so that the hub 26a is received in the receptacle 54a in only the illustrated proper orientation of the cutting string 32a. Insertion of the hub 26a in a different orientation (e.g., inverted, pivoted about its axis 90°, etc.) is inhibited by the shape of the hub 26a/receptacle 54a.

It should be understood that, in other constructions (not shown), other structure (e.g., inter-engageable projection and groove, blocking structure, other non-uniform outer shape, marking or other indication (“This side up”, “This side visible”, “Proper”, etc.) may be provided additionally or alternatively to ensure proper orientation of the cutting string(s) 32.

One or more independent features and independent advantages of the invention may be set forth in the following claims:

What is claimed is:

1. A trimmer head for use with a trimmer, the trimmer head comprising:
a housing rotatable about an axis;
a receptacle in the housing to receive a portion of a trimmer line; and
a locking member movable in a radial direction relative to the housing between a first position, in which the locking member engages the trimmer line to axially retain the trimmer line relative to the housing, and a second position, in which the trimmer line is movable relative to the receptacle.

2. The trimmer head of claim 1, wherein the trimmer line includes a hub and a cutting string, wherein the receptacle receives the hub, and wherein the locking member engages the hub.

3. The trimmer head of claim 2, wherein the trimmer line includes a hub and a plurality of cutting strings.

4. The trimmer head of claim 2, wherein the receptacle supports the hub for pivotable movement relative to the housing.

5. The trimmer head of claim 2, wherein the receptacle limits pivotal movement of the hub relative to the housing.

6. The trimmer head of claim 2, wherein the housing defines an opening through which the cutting string extends.

7. The trimmer head of claim 6, wherein the receptacle supports the hub for pivotable movement relative to the housing, and wherein the opening includes a slot allowing pivoting movement of the cutting string relative to the housing.

8. The trimmer head of claim 2, wherein the hub includes a protrusion, and wherein the receptacle receives the protrusion with the protrusion extending parallel to the axis.

9. The trimmer head of claim 1, wherein the locking member is flexible, the locking member being bendable between the first position and the second position.

10. The trimmer head of claim 1, wherein the locking member is biased toward the first position.

11. The trimmer head of claim 10, wherein the locking member has a sloped surface engageable by the trimmer line to move the locking member from the first position toward the second position to allow insertion of the portion of the trimmer line into the receptacle.

12. The trimmer head of claim 1, wherein the locking member is biased toward the second position, and wherein, during rotation of the housing, centrifugal force moves the locking member toward the first position.

13. A trimmer head for use with a trimmer, the trimmer head comprising:
a housing rotatable about an axis;
a receptacle in the housing to receive a portion of a trimmer line; and
a flexible locking member bendable in a radial direction relative to the housing between a first position, in which the locking member engages the trimmer line to axially retain the trimmer line relative to the housing, and a second position, in which the trimmer line is movable relative to the receptacle.

14. The trimmer head of claim 13, wherein the trimmer line includes a hub and at least one cutting string, wherein the receptacle receives the hub, and wherein the locking member engages the hub.

15. The trimmer head of claim 14, wherein the receptacle supports the hub for pivotable movement relative to the housing.

16. The trimmer head of claim 15, wherein the housing defines a slot through which the cutting string extends, the slot allowing pivoting movement of the cutting string relative to the housing.

17. The trimmer head of claim 14, wherein the receptacle limits pivotal movement of the hub relative to the housing.

18. The trimmer head of claim 14, wherein the hub includes a protrusion, and wherein the receptacle receives the protrusion with the protrusion extending parallel to the axis.

19. The trimmer head of claim 14, wherein the locking member is biased toward the first position.

20. The trimmer head of claim 19, wherein the locking member has a sloped surface engageable by the trimmer line to move the locking member from the first position toward the second position to allow insertion of the portion of the trimmer line into the receptacle.

21. The trimmer head of claim 14, wherein the locking member is biased toward the second position, and wherein, during rotation of the housing, centrifugal force moves the locking member toward the first position.

22. A method of assembling a trimmer head, the trimmer head including a housing rotatable about an axis, a receptacle in the housing, and a flexible locking member, the method comprising:
bending the locking member in a radial direction relative to the housing from a first position, in which the locking member at least partially blocks the receptacle, toward a second position, in which a portion of the trimmer line is insertable into the receptacle;
inserting the portion of the trimmer line into the receptacle; and
moving the locking member toward the first position to axially retain the trimmer line relative to the housing.

23. The method of claim 22, wherein bending includes bending, with an intrinsic biasing force, the locking member in a radial direction relative to the housing from a first position toward a second position.

24. The method of claim 22, wherein moving includes moving, with an intrinsic biasing force, the locking member toward the first position to axially retain the trimmer line relative to the housing.
